(19) United States
(12) Patent Application Publication
(10) Pub. No.: US 2026/0030023 A1
(43) Pub. Date: Jan. 29, 2026

(54) ARTIFICIAL INTELLIGENCE-BASED SYSTEM AND METHOD FOR GENERATING AND DEPLOYING APPLICATIONS VIA A COGNITIVE ENVIRONMENT

(71) Applicant: Cognizant Technology Solutions India Pvt. Ltd., Chennai (IN)

(72) Inventors: Pranit Modak, Kolkata (IN); Manish Shrikant Ansingkar, Pune (IN); Hareesh Mullappilly Unnipillai, Kochi (IN); Sreejith Gopalakrishna Pillai, Bangalore (IN); Arumugam Kumaradassan, Chennai (IN)

(21) Appl. No.: 18/891,202

(22) Filed: Sep. 20, 2024

(30) Foreign Application Priority Data
Jul. 24, 2024 (IN) 202441056434

(51) Int. Cl. G06F 8/77; G06F 8/60; G06F 11/36; G06N 3/0475

(52) U.S. Cl. CPC G06F 8/77; G06F 8/60; G06F 11/3604; G06N 3/0475

(57) ABSTRACT

Artificial Intelligence-based System and Method for Generating and Deploying Applications via a Cognitive Environment System and method for generating and deploying applications via cognitive environment is provided. Digital PODs comprising digital AI personas are triggered in response to system prompt for evaluating first set of features from input data using LLMs based on a predefined function to generate first outcome. First outcome is generated based on external data retrieved from external tools. First outcome is compared with input data and comparison is inputted to LLMs as prompt template. LLMs evaluate whether to proceed with next step in a series of steps associated with subsequent predefined functions to arrive at final outcome. Next step involves generating second outcome by extracting second set of features from first outcome and applying subsequent predefined function over first outcome. Series of steps are implemented till LLMs iteratively determine that the final outcome is comparable to desired outcome.

### FIELD OF THE INVENTION

The present invention relates generally to the field of application development and deployment, and more particularly the present invention relates to an artificial intelligence-based system and method for generating and deploying applications via a cognitive environment.

### BACKGROUND OF THE INVENTION

Typically, it takes a lot of time to develop a working application with human in loop for every assigned task in an agile Software Development Life Cycle (SDLC), which involves requirements gathering, design/architecting, coding and testing. Furthermore, in a standard SDLC, progression from conceptualization to realization of an industry-ready application is often characterized by extensive timelines. Moreover, the extended timeline is significantly exacerbated in instances where, upon development of a viable product, it is realized that a marginally altered ideation approach would have been preferable. Such realizations necessitate either a comprehensive redevelopment of the application from scratch or require substantial modifications that lead to delays in existing project timelines.

Also, due to proliferation of Generative Artificial Intelligence (GenAI) tools, process of feature development through continuous interaction with Artificial Intelligence (AI) presents a unique set of challenges. Typically, developers prompt the GenAI tools for specific features, subsequently integrating generated code into existing files alongside other AI generated components. However, such an integration process frequently causes errors, necessitating further rounds of prompting of GenAI tools to rectify the errors. In instances, where direct prompts fail to resolve the errors, additional and complex prompts are required to elucidate integration challenges among disparate codes and features, aiming to ensure continuity and coherence within application code.

Furthermore, iterative prompting and integration workflow, along with receiving packaging and deployment instructions from GenAI to make it understand specific environment details, often consumes approximately 90% of time that manual development would require. Consequently, perceived efficiency gains are substantially diminished, leading to reduced overall benefits of iterative prompting approach with regards to application development. Moreover, iterative prompting approach through GenAI complicates understanding of final application code structure. Also, absence of a straightforward method to comprehend fully developed application code further exacerbates challenges faced by developers, hindering efficient project progression and potentially impacting quality and maintainability of the software application.

Also, chatbot implementation of popular Large Language Models (LLMs) that generate application code is limited by amount of code that chatbots generate as output for a single prompt. Also, chatbots lack depth of generating correct code that a user runs in one shot. Moreover, LLMs also loose context of exact terms and definitions generated in earlier codes. Existing technologies also focus on creating a single stack or a maximum of two stack applications that is only good for single usage. None of the existing technologies creates multi-user and fully featured enterprise level applications desired by enterprises. Furthermore, existing technologies lack multiagent collaboration and micro-task creation from high-level starting task.

In light of the above drawbacks, there is a need for an artificial intelligence-based system and method for generating and deploying applications. There is a need for an artificial intelligence-based platform to provide a cognitive environment for developing and deploying applications with precision and efficiency. Also, there is a need for a system and a method that facilitates creation of multi-user enterprise grade full stack applications.

### SUMMARY OF THE INVENTION

In various embodiments of the present invention, a system (100) for generating and deploying applications via a cognitive environment is provided. The system (100) comprises a memory (114) storing program instructions and a processor (112) in communication with the memory (114) configured to execute an application generation and deployment engine (116). The processor (112) is configured to trigger digital Product Oriented Delivery (PODs) (104, 104a) comprising digital Artificial Intelligence (AI) personas in response to a system prompt for evaluating a first set of features from an input data using Large Language Models (LLMs) (106) based on a predefined function to generate a first outcome. The first outcome is generated on the basis of external data retrieved from one or more external tools. The processor (112) compares the first outcome with the input data and inputs the comparison to the LLMs (106) in the form of a prompt template. The LLMs (106) evaluate whether to proceed with a next step in a series of steps associated with one or more subsequent predefined functions to arrive at a final outcome. The next step involves generating a second outcome by extracting a second set of features from the first outcome and applying a subsequent predefined function over the first outcome. The processor (112) implements the series of steps till the LLMs (106) iteratively determine the final outcome to be comparable to a desired outcome.

In various embodiments of the present invention, a method for generating and deploying applications via a cognitive environment is provided. The method comprises triggering digital Product Oriented Delivery (PODs) (104, 104a) comprising digital Artificial Intelligence (AI) personas in response to a system prompt for evaluating a first set of features from an input data using Large Language Models (LLMs) (106) based on a predefined function to generate a first outcome. The first outcome is generated on the basis of external data retrieved from one or more external tools. The method comprises comparing the first outcome with the input data and inputs the comparison to the LLMs (106) in the form of a prompt template. The LLMs (106) evaluate whether to proceed with a next step in a series of steps associated with one or more subsequent predefined functions to arrive at a final outcome. The next step involves generating a second outcome by extracting a second set of features from the first outcome and applying a subsequent predefined function over the first outcome. The method comprises implementing the series of steps till the LLMs (106) iteratively determine the final outcome to be comparable to a desired outcome.

In various embodiments of the present invention, a computer program product is provided. The computer program product comprises a non-transitory computer-readable medium having computer program code stored thereon, the computer-readable program code comprising instructions that, when executed by a processor, causes the processor to trigger digital Product Oriented Delivery (PODs) comprising digital Artificial Intelligence (AI) personas in response to a system prompt. A first set of features from an input data are evaluated using Large Language Model (LLMs) based on a predefined function to generate a first outcome. The first outcome is generated on the basis of external data retrieved from one or more external tools. The first outcome is compared with the input data and the comparison is inputted to the LLMs in the form of a prompt template. The LLMs evaluate whether to proceed with a next step in a series of steps associated with one or more subsequent predefined functions to arrive at a final outcome. The next step involves generating a second outcome by extracting a second set of features from the first outcome and applying a subsequent predefined function over the first outcome. The series of steps are implemented till the LLMs iteratively determine the final outcome to be comparable to a desired outcome.

### BRIEF DESCRIPTION OF THE ACCOMPANYING DRAWINGS

The present invention is described by way of embodiments illustrated in the accompanying drawings wherein:

FIG. 1-1a illustrates a block diagram of an artificial intelligence-based system for generating and deploying applications via a cognitive environment, in accordance with an embodiment of the present invention;

FIGS. 2, 3, 4a, and 4b illustrate a user interface of the artificial intelligence-based system for generating and deploying applications via the cognitive environment, and

FIG. 4c illustrates front-end framework of the system, in accordance with an embodiment of the present invention;

FIG. 4d illustrates a flowchart of a method for generating and deploying applications via a cognitive environment, in accordance with an embodiment of the present invention; and

FIG. 5 illustrates an exemplary computer system in which various embodiments of the present invention may be implemented.

### DETAILED DESCRIPTION OF THE INVENTION

The disclosure is provided in order to enable a person having ordinary skill in the art to practice the invention. Exemplary embodiments herein are provided only for illustrative purposes and various modifications will be readily apparent to persons skilled in the art. The general principles defined herein may be applied to other embodiments and applications without departing from the scope of the invention. The terminology and phraseology used herein is for the purpose of describing exemplary embodiments and should not be considered limiting. Thus, the present invention is to be accorded the widest scope encompassing numerous alternatives, modifications and equivalents consistent with the principles and features disclosed herein. For purposes of clarity, details relating to technical material that is known in the technical fields related to the invention have been briefly described or omitted so as not to unnecessarily obscure the present invention.

The present invention would now be discussed in context of embodiments as illustrated in the accompanying drawings.

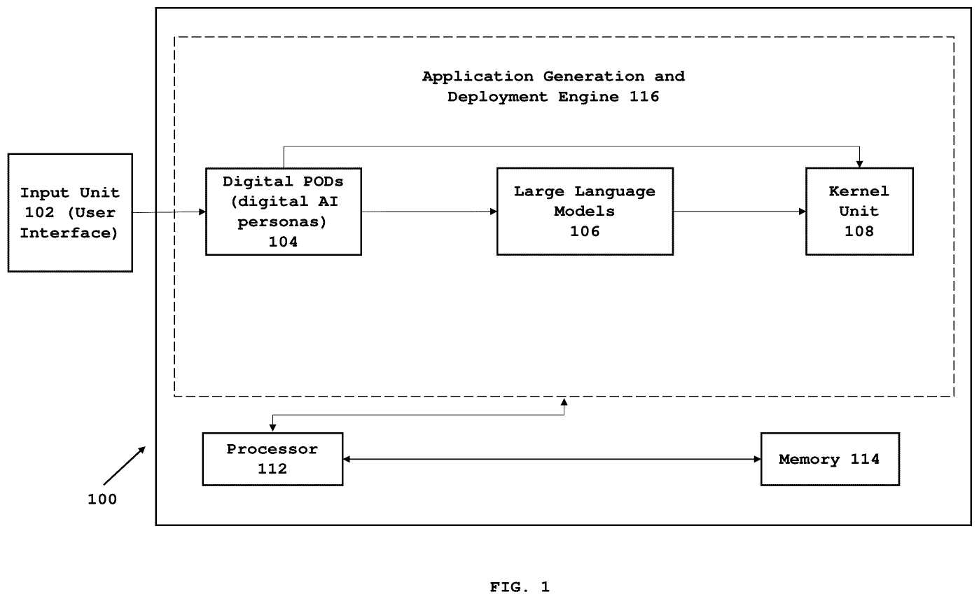

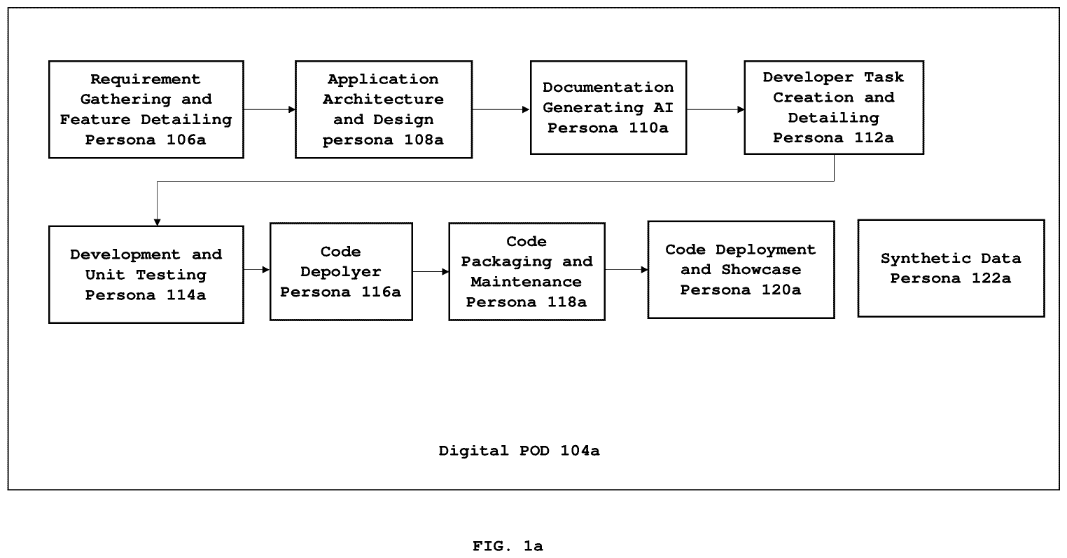

FIGS. 1 and 1a is a block diagram of a system 100 for generating and deploying applications via a cognitive environment, in accordance with various embodiments of the present invention. The system 100 is an artificial intelligence-based team workflow platform for generation and deployment of applications. The system 100 is configured to provide a cognitive environment by employing kernel linked containers for generating and deploying applications. The system 1100 facilitates delivery of fully deployable and functional applications.

In an embodiment of the present invention, the system 100 comprises an input unit 102 and an application generation and deployment engine 116. The application generation and deployment engine 116 comprises Digital Product Oriented Delivery (POD) (digital PODs) 104, 104a, Large Language Models (LLMs) 106 and a kernel unit 108. In an embodiment of the present invention, the units of the system 100 operate in conjunction with each other and are operated via a processor 112 specifically programmed to execute instructions stored in a memory 114 for executing respective functionalities of the units of the system 100.

In an embodiment of the present invention, the system 100 may be implemented in a cloud computing architecture in which data, applications, services, and other resources are stored and delivered through shared data centres. In an exemplary embodiment of the present invention, the functionalities of the system 100 are delivered to a user as Software as a Service (SaaS) or Platform as a Service (PaaS) over a communication network.

In another embodiment of the present invention, the system 100 may be implemented as a client-server architecture. In this embodiment of the present invention, a client terminal accesses a server hosting the system 100 over a communication network. The client terminals may include but are not limited to a smart phone, a computer, a tablet, microcomputer or any other wired or wireless terminal. The server may be a centralized or a decentralized server. The server may be located on a public/private cloud or locally on a particular premise.

In an embodiment of the present invention, the input unit 102 renders a front-end user interface (UI) of the application generation and deployment engine 116. The input unit 102 is configured to provide a secure user authentication through Azure AD OAuth® for robust security and seamless integration with other Azure® services. The UI of the input unit 102 provides various options for creation and deployment of applications and viewing and management of one or more generated and deployed applications by providing options including, but are not limited to, application details, session/state management and a toggle tab for review before the application is generated.

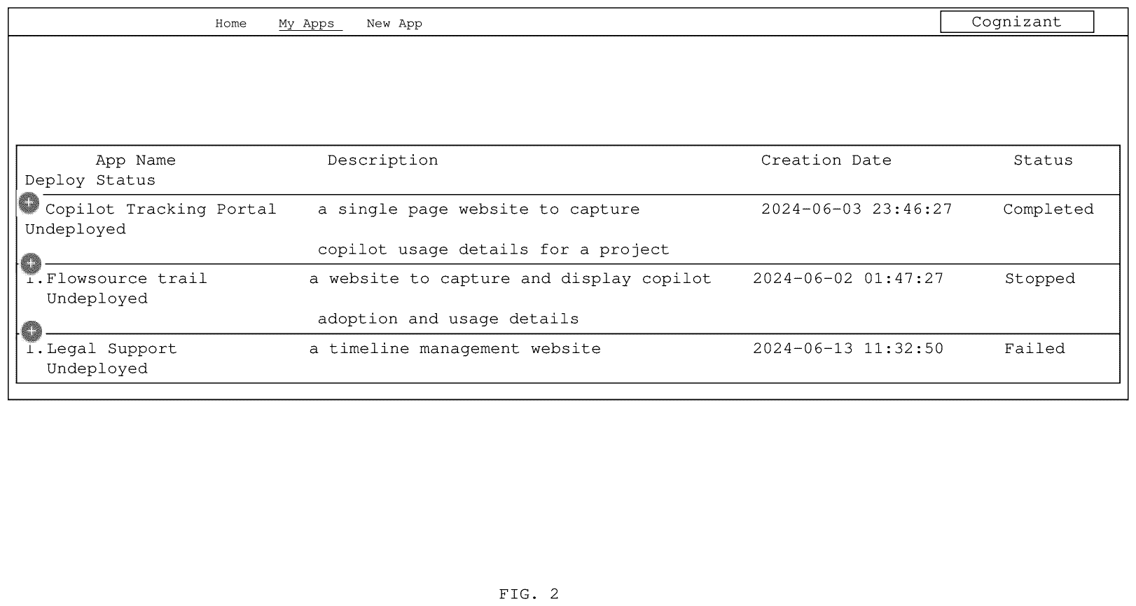

In an embodiment of the present invention, the users may control and manage application deployment and handle multiple application generation simultaneously via the input unit 102. The users may view, resume, stop or delete the application generation process and deploy or launch finalised application via the UI of the input unit 102. In an exemplary embodiment of the present invention, FIGS. 2-4 illustrate the UI rendered via the input unit 102, in accordance with an embodiment of the present invention.

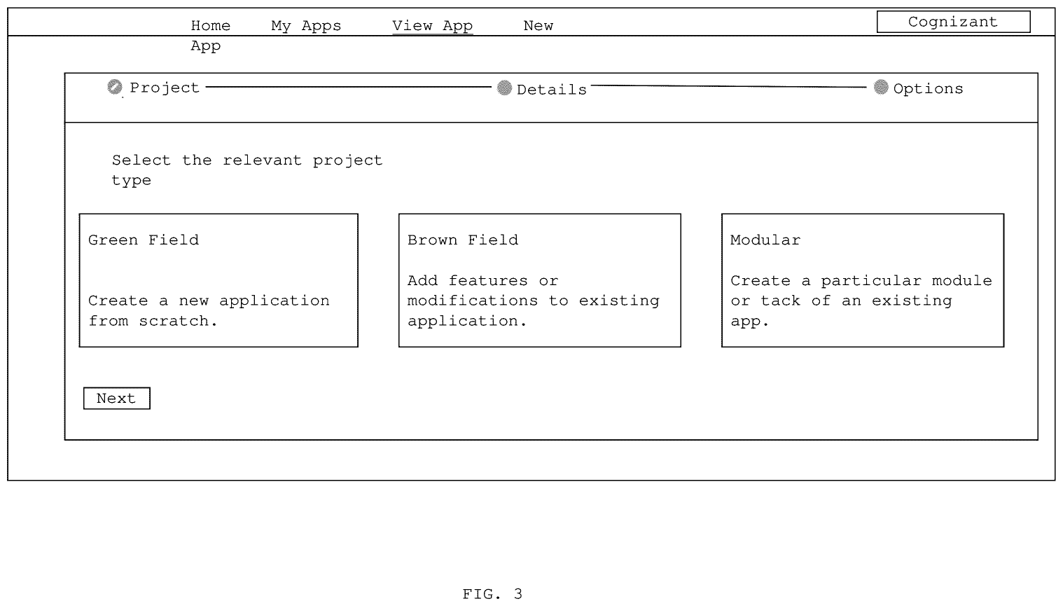

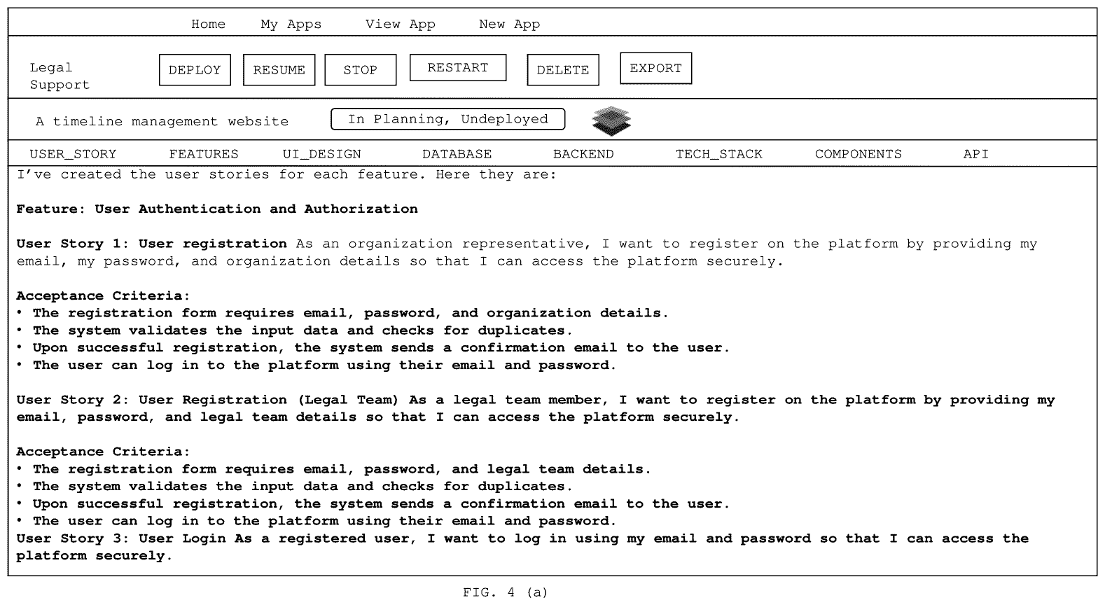

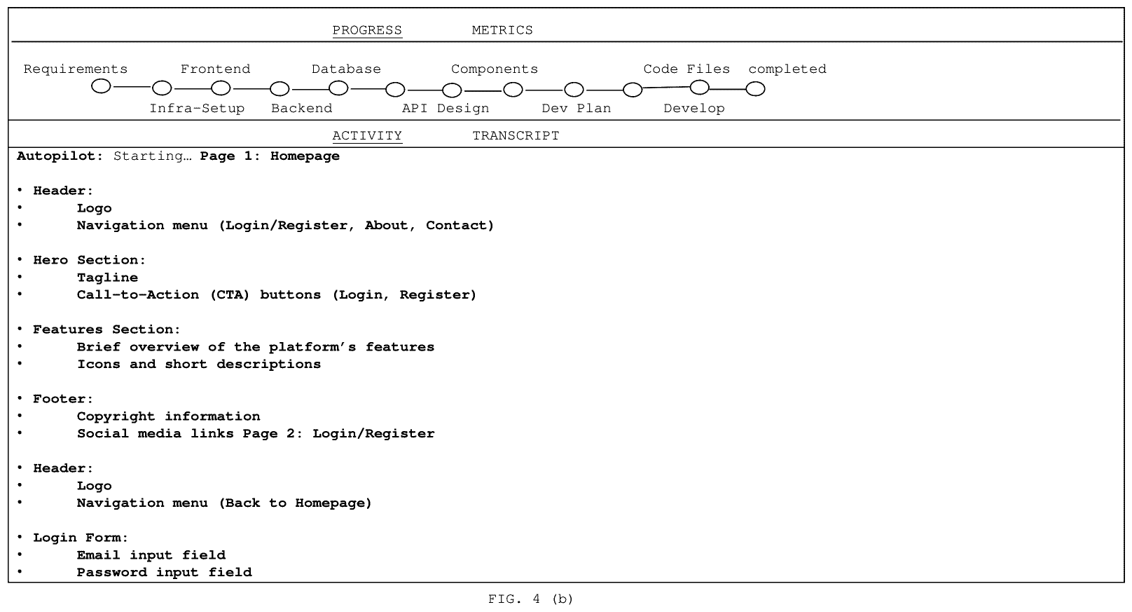

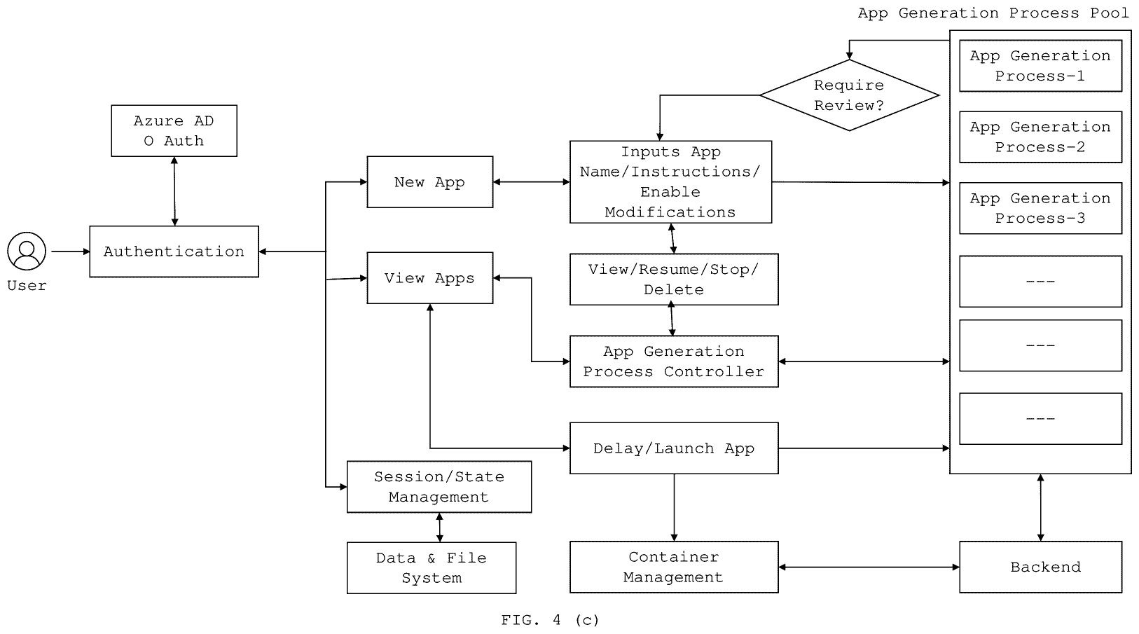

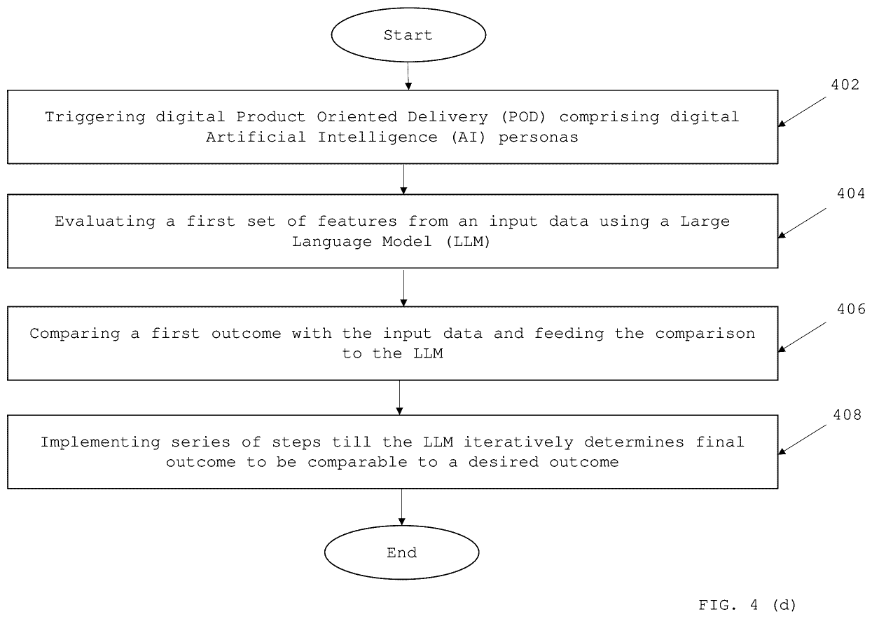

FIG. 2 illustrates status of generation and deployment of application, in accordance with an embodiment of the present invention. As shown in FIG. 3, the UI illustrates an option to create applications from a single input data for greenfield application development, where the input data may be in form of a prompt, in an embodiment of the present invention. FIG. 3 also illustrates option to create an application by adding features to existing applications and codebase using one or more prompts and an option to create customisable application from stack specific instructions and architecture, in accordance with an embodiment of the present invention. FIGS. 4a and 4b illustrate creation of the application via a user story entered by the user, in accordance with an embodiment of the present invention.

In an embodiment of the present invention, the UI rendered by the input unit 102 includes the toggle tab ‘Enable Feature Modifications’ that provides an option of review before creation of the application. In another embodiment of the present invention, the UI includes a view app option to view a list of one or more generated applications. The view option may include details such as, but not limited to, status of the application, creation date, and an option to view more detailed information as illustrated in FIG. 4c. In yet another embodiment of the present invention, as shown in FIG. 4c, the UI includes an option of session/state management for managing user session to ensure a stateful interaction within the generated application. The session/state management option is configured to keep track of user actions and data during application interaction process. In another embodiment of the present invention, the UI includes a data and file system option to manage storage and retrieval of data and files that are necessary for generation and operation of applications using the system 100.

In an embodiment of the present invention, the application generation and deployment engine 116 provides for a cognitive environment where one or more AI personas collaborate to complete one or more tasks during each phase of a software development lifecycle, similar to real-life software development teams. The AI personas are enabled to carry out digitised activities during an application development and deployment process, that are traditionally carried out by humans, for example, human technical leads, project managers, product owners, DevOps engineers, infrastructure developers, testers etc.

In various embodiments of the present invention, the application generation and deployment engine 116 comprises digital PODs 104, 104a that are configured to leverage LLMs 106 for generation and deployment of applications. In an exemplary embodiment of the present invention, the digital PODs 104, 104a are configured to leverage LLMs 106 across four dimensions including, but not limited to, decision, documentation, development and deployment. The digital PODs 104, 104a comprise one or more digital AI personas that are designed with specialized functionalities to accomplish tasks in each phase of application development process.

In an embodiment of the present invention, the digital AI personas relate to one or more small, cross functional team of business and technology professionals that work together to handle one or more aspects of a project from development stage to maintenance stage. In an embodiment of the present invention, the digital PODs 104, 104a enable the AI personas to collaborate on tasks in each phase of the application development process by interfacing with LLMs 106 to complete the tasks effectively. The application generation and deployment engine 116, therefore, provides for transforming LLMs 106 to Large Action Models (LAMs) such that each phase of the application development process is executed with precision and efficiency. In various embodiments of the present invention, the digital PODs 104, 104a include one or more AI personas with capability to collaborate with each other from feature extraction to deployment stages and deliver a functional enterprise grade multi-user full stack application.

In an embodiment of the present invention, each digital AI persona is configured to implement a series of steps to generate an outcome. In an embodiment of the present invention, the application generation and deployment engine 116 is configured to trigger one or more digital AI personas in the digital PODs 104, 104a based on a system prompt.

In an embodiment of the present invention, the AI personas interface with one or more Large Language Models (LLMs) 106 based on an input data received via the input unit 102 to generate a final outcome, where the final outcome is generated based on a series of steps. A first step of the series of the steps involves evaluating a first set of features from the input data using the LLM 106 based on a predefined function to generate a first outcome. The first outcome is generated on the basis of external data retrieved from one or more external tools/API employing the kernel unit 108. The generated first outcome is fed back to the LLM 106 in the form of a prompt template where the LLM 106 evaluates whether to proceed with a next step (e.g., second step) in the series of steps to arrive at the final outcome.

In an exemplary embodiment of the present invention, the generated first outcome is compared with the input data and the comparison is fed to the LLM 106 in the form of a prompt template for the LLM 106 to evaluate requirement to proceed to the second step. The second step involves generating a second outcome by extracting a second set of features from the first outcome and applying a subsequent predefined function over the first outcome. In an exemplary embodiment of the present invention, the second step involves evaluating the first outcome on the basis of a predefined function and external data retrieved from one or more tools. The AI personas are configured to implement series of steps till a stage where the LLM 106 iteratively determines that the final outcome is comparable or similar to or same as a desired outcome. In an embodiment of the present invention, one or more AI personas perform content modification iteratively.

In an embodiment of the present invention, the digital PODs 104, 104a are executed on the basis of an attention mechanism that allows the digital PODs 104, 104a to focus on different parts of the input data, thereby capturing nuanced meanings and relationships between words and phrases in the input data. The digital PODs 104, 104a are configured to leverage extensive training data and pre-established patterns to infer core functionality and purpose of the input data in form of an application to be deployed as envisioned by a user. In an embodiment of the present invention, the LLM 106 is based on a transformer-based architecture leading to agentic flow of the AI Personas in the digital PODs 104, 104a thereby ensuring that generated final outcome is coherent, contextually relevant, and comprehensive.

In an embodiment of the present invention, the digital PODs 104, 104a comprise a requirement gathering and feature detailing persona 106a that comprises digital AI personas of a UI designer, a product owner and a user for requirement gathering and feature extraction. The requirement gathering and feature extraction AI persona 106a extracts a feature data from input data received via the input unit 102. In an embodiment of the present invention, the input data may be in the form of user stories and wireframe data. The requirement gathering and feature detailing persona 106a is configured to parse the input data to extract the feature data and generate a first output data. The first output data is a result of implementation of the series of steps till the LLM (106) iteratively determines that the final outcome is comparable to the desired outcome mentioned above.

In an exemplary embodiment of the present invention, the input data includes a first input data that relates to application name where the users may specify name of the application. In another exemplary embodiment of the present invention, the input data may include a second input data that relates to specific instructions or parameters for generation of application. In another exemplary embodiment of the present invention, the input data includes a third input data that relates to data required for enabling feature modifications that allows the user to decide if the generated application needs to go through a review process thereby adding an additional layer of quality control.

In yet another exemplary embodiment of the present invention, the input data includes a fourth input data that relates to, but not limited to, providing control to the user to view progress, resuming a paused application generation, stopping the application generation or deleting the application. In another exemplary embodiment of the present invention, the input data may be customized based on, but not limited to, pre-defined features or new proposed features. Advantageously, level of customization ensures that application generation process is highly adaptive and responsive to user requirements.

In an embodiment of the present invention, the digital PODs 104, 104a comprise an application architecture and design persona 108a that includes digital AI personas of an application architect, project manager and a technical lead. The application architecture and design persona 108a is configured to fetch the first output data from the requirement gathering and feature detailing persona 106a and generates a second output data in terms of comprehensive documentation covering all critical aspects of application development. The second output data is a result of implementation of the series of steps till the LLM (106) iteratively determines that the final outcome is comparable to the desired outcome mentioned above.

In an embodiment of the present invention, the documentation generating AI personas 110a receives the second output data from the application architecture and design persona 108a and generates a third output data that includes details associated with the application architecture, user interface, backend and database design. In an exemplary embodiment of the present invention, the third output data includes details relating to selecting appropriate technology stack to formulate high level designs that includes one or more detailed development task relating to a software developer. The third output data is a result of implementation of the series of steps till the LLM (106) iteratively determines that the final outcome is comparable to the desired outcome mentioned above.

In an embodiment of the present invention, the digital PODs 104, 104a comprise a developer task creation and detailing persona 112a that comprises digital AI personas of technical lead and project manager for task allocation. The developer task creation and detailing persona 112a is configured to decompose the third output data received from the documentation generating AI personas 110a into micro tasks that enables development and unit testing AI personas 114a to generate code that maintain full context of the project involved in the application development process (explained here in below).

In an embodiment of the present invention, the digital PODs 104, 104a comprise a development and unit testing persona 114a that comprises one or more digital developer AI personas and code deployer personas of developer, tester, and project manager for generating and deploying code for the application, thereby mimicking human software engineers. In an embodiment of the present invention, the developer AI personas interface with the LLMS 106 based on the micro tasks received from the developer task creation and detailing persona 112a to generate the code for the application. The developer AI personas input the micro tasks into the LLMs 106, which aids in focused and efficient code generation. The generation and deployment of code is a result of implementation of the series of steps till the LLM (106) iteratively determines that the final outcome is comparable to the desired outcome mentioned above.

In an embodiment of the present invention, the developer AI personas are enabled by the development and unit testing persona 114a to access the kernel unit 108 to enable the developer AI personas to write code using the LLMs 106, as well as execute, save and test code. In an embodiment of the present invention, the kernel unit 108 includes one or more kernels that are python libraries with a pluggable option for different languages. Each language has a specific way of setting up the environment, writing the code, executing the code, getting execution and error logs for the code and seeing the output of the code.

In an embodiment of the present invention, the code deployer persona 116a is configured to extract generated code segments and instructions and perform coding language detection using LLM 106 for each code segment in the generated code, to trigger one or more rules based on a detected language, thereby selecting specific custom language executor. The code deployer persona 116a is configured to execute the code segment or/and pre-development commands or instructions (that gets converted to an executable command using LLM 106) in a development environment setup, utilizing one or more dockers. In an embodiment of the present invention, the code deployer persona 116a is configured to write code to files according to file names or location provided by developer AI Persona.

In an embodiment of the present invention, the custom language executor is an integral component of kernel unit 108 that is designed to be invoked based on detected programming or scripting language within the kernel unit 108. After parsing the LLM response into appropriate commands, instructions, and code segments, the custom language executor connects to one or more dockers and executes relevant commands, instructions, or environment configurations, ensuring seamless integration and operation within a specified development context.

In an embodiment of the present invention, the kernel unit 108 executes the code in a language specific way, takes the output along with execution logs and presents it in a way to the developer AI personas such that the developer AI personas are able to understand the execution to identify errors and correct the errors, update and debug code, manage code dependencies and modify variables and configurations to generate deployable application code. In an embodiment of the present invention, the kernel unit 108 is configured to decipher code output of LLMs 106 into tangible actions pertaining to a specific language and framework. The kernel unit 108 performs response detailing character filtration and code instruction extraction on the code output of the LLMs 106 such that the generated application code is divided into one or more micro units of code, commands and environment instructions. The kernel unit 108 repeats this process for each and every task given by the task allocation AI personas until the whole application that was initially divided into tasks is fully developed.

In an embodiment of the present invention, the kernel unit 108 is configured to generate docker containers for the developed application through a host docker client via a socket service. In an embodiment of the present invention, the kernel unit 108 is configured to select a base image and then prepare an image in the form of container configuration (docker-compose.yml) utilising the LLM 106. The image is a read only template that include instructions for creating a container. In an embodiment of the present invention, the image is a snapshot or a blueprint of one or more libraries and dependencies required inside a container for an application to run.

In an embodiment of the present invention, once the image is configured for a selected language stack, it is then deployed by the code deployer persona 116a and a live connection socket is passed to corresponding language kernel. The kernel unit 108 is configured to execute commands/instructions, write codes files and perform other development tasks for the selected language stack. Further, modifications to the code are confined to the docker containers such that the system 100 remains secure during code development process. The kernel unit 108 improves future iterations of the docker containers that may be used to interact with new custom kernels that may be integrated and utilised as required.

In an embodiment of the present invention, the kernel unit 108 provides for provisions to add plugin executor. The plugin executor provides language specific formatting and instructions to extend capability of the AI personas to setup, code, execute and visualize results of the different programming languages. For example, the different programming languages include ‘React’ and ‘Postgres’. A template is maintained in the kernel unit 108 for all the different languages. In an embodiment of the present invention, the kernel unit 108 comprises a wrapper that receives the instructions and sets up a language specific environment such that any code to be written in a file structure suggested by the developer AI personas is accomplished similar to that executed by a human. The kernel unit 108 is configured to set up the language specific environment and generate docker containers for the developed application through the host docker client via the socket service.

In an embodiment of the present invention, the developer AI personas are enabled to test each piece of code to ensure functionality and reliability of the code. The generated code is stored as code files in a code repository that is automatically scanned for quality and potential vulnerabilities such that the generated code is functional and secure. In various embodiments of the present invention, the AI personas equipped with LLMs 106 operate through text generation for performing complex tasks including, but are not limited to, creating architectural visuals, conducting code syntax checks, and verifying code versions.

In an embodiment of the present invention, the digital PODs 104, 104a comprise a code packaging and maintenance persona 118a that comprises digital AI personas of DevOps Engineer. All the completed code files and environment details are received by the code packaging and maintenance persona 118a from the code deployer persona 116a that enables the code packaging and maintenance AI personas 118a to sync the generated code to specific git repositories and package the code to docker images with configuration details. The packaging and maintenance of code is a result of implementation of the series of steps till the LLM 106 iteratively determines that the final outcome is comparable to the desired outcome.

In an embodiment of the present invention, the digital PODs 104, 104a comprise code deployment and showcase persona 120a that comprises digital AI personas of infrastructure and users for deployment of the application for immediate use by multiple users by employing the packaged code based on input provided by code packaging and maintenance persona 118a. The deployment of code is a result of implementation of the series of steps till the LLM 106 iteratively determines that the final outcome is comparable to the desired outcome.

In an embodiment of the present invention, the generated code after deploying a developer environment with the base image customization is temporary and gets removed if anything happens to the dev container. Therefore, for keeping the generated code as easily exportable and also retaining the generated code in its individuality without any code loss due to container or other issues, the generated code is packaged into an image like the base image by the code packaging and maintenance persona 118a. The kernel unit 108 creates configurations of the image by building a code file (docker file) employing the LLMs 106. The created configurations are converted into absolute image build commands by the code packaging and maintenance persona 118a using the kernel unit 108 based on rules defined for the generated code.

In an embodiment of the present invention, the code packaging and maintenance persona 118a commands the docker files for the image to be built where structuring of the image also involves moving the generated code from a previous created dev container to a new dev container. In an embodiment of the present invention, the code packaging and maintenance persona 118a analyses history of pre-developed containers and commands to generate commands for the docker files. The kernel unit 108 is configured to generate an entry point of the application into the docker file by pre-defined rules to start developing application stack once the image is deployed in the docker file. Once the generated code is packaged into the image, deployment of the image is performed by the kernel unit 108 in same way as the base image was deployed through code (standard set of commands available along with base images like—node-alpine, python-alpine).

In various embodiments of the present invention, the digital PODs 104, 104a comprise one or more dedicated synthetic data persona 122a with capabilities of populating synthetic data for demonstrating functional capabilities of the developed application in real-world scenarios.

FIG. 4(d) is a flowchart illustrating a method for generating and deploying applications via a cognitive environment, in accordance with an embodiment of the present invention.

At step 402, digital PODs comprising AI personas are triggered. In an embodiment of the present invention, the digital PODs leverage LLMs for generation and deployment of applications. In an exemplary embodiment of the present invention, the LLMs are leveraged across four dimensions including, but not limited to, decision, documentation, development and deployment. The digital PODs are designed with specialized functionalities to accomplish tasks in each phase of application development process. The digital AI personas in the digital PODs are triggered based on a system prompt, and each digital AI persona implements a series of steps to generate an outcome.

In an embodiment of the present invention, the digital AI personas relate to one or more small, cross functional team of business and technology professionals that work together to handle one or more aspects of a project from development stage to maintenance stage. The AI personas are enabled to collaborate on tasks in each phase of the application development process by interfacing with LLMs to complete the tasks effectively. The LLMs are transformed into Large Action Models (LAMs) such that each phase of the application development process is executed with precision and efficiency. In various embodiments of the present invention, one or more AI personas are provided with capability to collaborate with each other from feature extraction to deployment stages and deliver a functional enterprise grade multi-user full stack application.

At step 404, a first set of features are evaluated from an input data. In an embodiment of the present invention, based on an input data received via the input unit, the AI personas interface with one or more Large Language Models (LLMs) to generate a final outcome, where the final outcome is generated based on a series of steps. A first step of the series of the steps involves evaluating a first set of features from the input data using the LLM based on a predefined function to generate a first outcome. The first outcome is generated on the basis of external data retrieved from one or more external tools/API employing the kernel unit. The generated first outcome is fed back to the LLM in the form of a prompt template where the LLM evaluates whether to proceed with a next step (e.g., second step) in the series of steps to arrive at the final outcome, as discussed in conjunction with FIGS. 1-1a

At step 404, a first outcome is compared with the input data and the comparison is fed to the LLM. In an embodiment of the present invention, the generated first outcome is compared with the input data and the comparison is fed to the LLM in the form of a prompt template for the LLM to evaluate requirement to proceed to the second step. The second step involves generating a second outcome by extracting a second set of features from the first outcome and applying a subsequent predefined function over the first outcome. In an exemplary embodiment of the present invention, the second step involves evaluating the first outcome on the basis of a predefined function and external data retrieved from one or more tools, as discussed in conjunction with FIGS. 1-1a.

At step 408, a series of steps are implemented till the LLM iteratively determines final outcome to be comparable to the desired outcome, as discussed in conjunction with FIGS. 1-1a.

Advantageously, the present invention provides for an innovative AI-driven platform (system 100) designed to optimise the Software Development Life Cycle (SDLC) through integration of advanced LLMs transformed into LAMs. The system 100 provides for a digital PODs environment that virtualizes a real-life product development team setting, where AI personas collaborate to complete tasks efficiently. By harnessing the capabilities of AI personas with specialized abilities, the system 100 enhances each phase of the application development process, from feature extraction to deployment, with unprecedented precision and efficiency. Further, the present invention provides for extraction and customization of detailed features from user requests, ensuring adaptability and responsiveness to user needs throughout the development process. The present invention provides for AI personas specifically designed to integrate into advanced SDLC workflow, thereby optimizing the capabilities of modern LLMs. Also, the present invention provides improvements in computation and processing within the SDLC by optimizing resource allocation, improving efficiency in code generation, and reducing processing time in development, deployment and testing phases. These improvements streamline overall SDLC, leading to faster and optimised iterations, reduced errors, and improved productivity with less manual efforts.

Furthermore, the digital PODs environment, like real-life development scenarios, takes into account collaboration within multiple AI personas who have a very specific purpose in the whole development cycle that facilitates continuity of the whole process and consequently each standard feature of software being developed is covered thoroughly throughout the code. This further ensures that the different stacks of the application being developed does not lose context or parity and behave in a coherent manner like a full stack application maintaining the intricate details such that an enterprise grade application/product is developed.

Yet further, the present invention provides for extrapolating features from a single prompt and iterate on the features for refining and finetuning details of each and every user interaction of the application and builds subsequent stacks of technologies on top of it. Also, after getting detailed development structure, the present invention develops, and self-healing the code and adjusting its development system as and when required. The system 100, therefore, creates proper multi-user enterprise grade applications in contrast to single-user Proof of Concept (POC) type applications building built by other existing technologies. The system 100 sets a new benchmark in AI-driven development, transforming generative AI from mere helpers to comprehensive doers and implementers within the SDLC. In various embodiments of the present invention, the digital PODs 104, 104a comprises one or more dedicated synthetic data personas 122a with capabilities of populating synthetic data for demonstrating functional capabilities of the developed application in real-world scenarios.

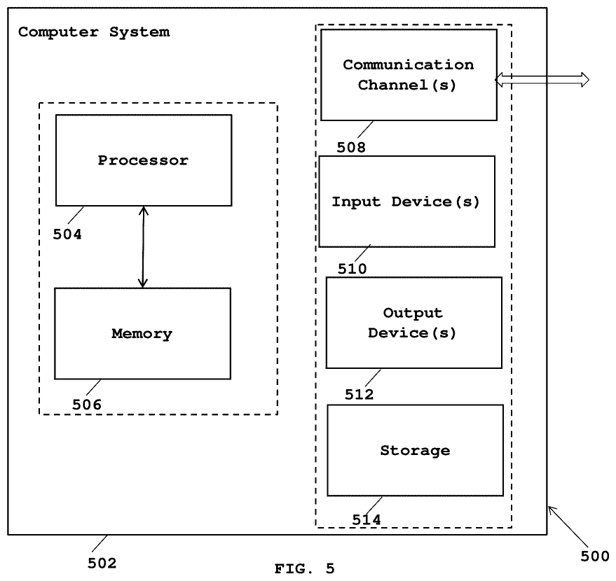

FIG. 5 illustrates an exemplary computer system in which various embodiments of the present invention may be implemented. The computer system 502 comprises a processor 504 and a memory 506. The processor 504 executes program instructions and is a real processor. The computer system 502 is not intended to suggest any limitation as to scope of use or functionality of described embodiments. For example, the computer system 502 may include, but not limited to, a programmed microprocessor, a micro-controller, a peripheral integrated circuit element, and other devices or arrangements of devices that are capable of implementing the steps that constitute the method of the present invention. In an embodiment of the present invention, the memory 506 may store software for implementing an embodiment of the present invention. The computer system 502 may have additional components. For example, the computer system 502 includes one or more communication channels 508, one or more input devices 510, one or more output devices 512, and storage 514. An interconnection mechanism (not shown) such as a bus, controller, or network, interconnects the components of the computer system 502. In an embodiment of the present invention, operating system software (not shown) provides an operating environment for various software executing in the computer system 502 and manages different functionalities of the components of the computer system 502.

The communication channel(s) 508 allow communication over a communication medium to various other computing entities. The communication medium provides information such as program instructions, or other data in a communication media. The communication media includes, but not limited to, wired or wireless methodologies implemented with an electrical, optical, RF, infrared, acoustic, microwave, Bluetooth or other transmission media.

The input device(s) 510 may include, but not limited to, a keyboard, mouse, pen, joystick, trackball, a voice device, a scanning device, touch screen or any another device that is capable of providing input to the computer system 502. In an embodiment of the present invention, the input device(s) 510 may be a sound card or similar device that accepts audio input in analog or digital form. The output device(s) 512 may include, but not limited to, a user interface on CRT or LCD, printer, speaker, CD/DVD writer, or any other device that provides output from the computer system 502.

The storage 514 may include, but not limited to, magnetic disks, magnetic tapes, CD-ROMs, CD-RWs, DVDs, flash drives or any other medium which can be used to store information and can be accessed by the computer system 502. In an embodiment of the present invention, the storage 514 contains program instructions for implementing the described embodiments.

The present invention may suitably be embodied as a computer program product for use with the computer system 502. The method described herein is typically implemented as a computer program product, comprising a set of program instructions which is executed by the computer system 502 or any other similar device. The set of program instructions may be a series of computer readable codes stored on a tangible medium, such as a computer readable storage medium (storage 514), for example, diskette, CD-ROM, ROM, flash drives or hard disk, or transmittable to the computer system 502, via a modem or other interface device, over either a tangible medium, including but not limited to optical or analogue communications channel(s) 508. The implementation of the invention as a computer program product may be in an intangible form using wireless techniques, including but not limited to microwave, infrared, Bluetooth or other transmission techniques. These instructions can be preloaded into a system or recorded on a storage medium such as a CD-ROM, or made available for downloading over a network such as the internet or a mobile telephone network. The series of computer readable instructions may embody all or part of the functionality previously described herein.

The present invention may be implemented in numerous ways including as a system, a method, or a computer program product such as a computer readable storage medium or a computer network wherein programming instructions are communicated from a remote location.

While the exemplary embodiments of the present invention are described and illustrated herein, it will be appreciated that they are merely illustrative. It will be understood by those skilled in the art that various modifications in form and detail may be made therein without departing from the scope of the invention.

We claim:

1. A system for generating and deploying applications via a cognitive environment, the system comprising:
a memory storing program instructions;
a processor in communication with the memory configured to execute an application generation and deployment engine to:
trigger digital Product Oriented Delivery (PODs) comprising digital Artificial Intelligence (AI) personas in response to a system prompt for:
evaluating a first set of features from an input data using Large Language Models (LLMs) based on a predefined function to generate a first outcome, wherein the first outcome is generated on the basis of external data retrieved from one or more external tools;
comparing the first outcome with the input data and inputting the comparison to the LLMs in the form of a prompt template, wherein the LLMs evaluate whether to proceed with a next step in a series of steps associated with one or more subsequent predefined functions to arrive at a final outcome, wherein the next step involves generating a second outcome by extracting a second set of features from the first outcome and applying a subsequent predefined function over the first outcome; and
implementing the series of steps till the LLMs iteratively determine the final outcome to be comparable to a desired outcome.

2. The system as claimed in claim 1, wherein the application generation and deployment engine comprises the digital PODs that enable the digital AI personas to collaborate on tasks in each phase of application development process by interfacing with the LLMs.

3. The system as claimed in claim 1, wherein the digital PODs comprise a requirement gathering and feature detailing persona that comprises digital AI personas of a UI designer, a product owner and a user for requirement gathering and feature extraction and configured to:
parse input data received via an input unit to extract feature data; and
generate a first output data, wherein the first output data is a result of implementation of the series of steps till the LLMs iteratively determine that the final outcome is comparable to the desired outcome.

4. The system as claimed in claim 3, wherein the input data comprises:
a first input data that relates to application name where the users may specify name of the application;
a second input data that relates to specific instructions or parameters for generation of application;
a third input data that relates to data required for enabling feature modifications that allows the user to decide if the generated application needs to go through a review process thereby adding an additional layer of quality control; and
a fourth input data that relates to providing control to the user to view progress, resuming a paused application generation, stopping the application generation or deleting the application.

5. The system as claimed in claim 1, wherein the digital PODs comprise an application architecture and design persona that includes digital AI personas of an application architect, project manager and a technical lead and configured to:
fetch the first output data from the requirement gathering and feature detailing persona and generate a second output data in terms of comprehensive documentation covering all critical aspects of application development, wherein the second output data is a result of implementation of the series of steps till the LLMs iteratively determine that the final outcome is comparable to the desired outcome.

6. The system as claimed in claim 5, wherein the digital PODs comprise documentation generating AI personas that receive the second output data from the application architecture and design persona and generate a third output data that includes:
details associated with the application architecture, user interface, backend and database design; and
details relating to selecting appropriate technology stack to formulate high level designs that includes one or more detailed development task relating to a software developer, wherein the third output data is a result of implementation of the series of steps till the LLMs iteratively determine that the final outcome is comparable to the desired outcome.

7. The system as claimed in claim 6, wherein the digital PODs comprise a developer task creation and detailing persona that comprises digital AI personas of technical lead and project manager configured to:
decompose the third output data received from the documentation generating AI personas into micro tasks for task allocation.

8. The system as claimed in claim 7, wherein the digital PODs comprise a development and unit testing persona that includes one or more digital developer AI personas and code deployer personas of developer, tester, and project manager for generating code for the application, wherein the digital developer AI personas interface with the LLMs based on micro tasks received from the developer task creation and detailing persona to generate and deploy code for the application by accessing a kernel unit for writing code, saving code and testing code, wherein the generation and deployment of code is a result of implementation of the series of steps till the LLMs iteratively determine that the final outcome is comparable to the desired outcome.

9. The system as claimed in claim 8, wherein the code deployer persona is configured to:
extract generated code segments and instructions;
perform coding language detection using LLM for each code segment in the generated code to trigger one or more rules based on a detected language thereby selecting a specific custom language executor;
execute the code segment and pre-development commands or instructions in a development environment setup, utilizing one or more dockers; and
write code to files according to file names or location.

10. The system as claimed in claim 9, wherein the custom language executor is designed to be invoked based on detected programming or scripting language and connects to one or more dockers and executes relevant commands, instructions, or environment configurations, ensuring seamless integration and operation within a specified development context after parsing the LLMs response into appropriate commands, instructions, and code segments.

11. The system as claimed in claim 9, wherein the kernel unit is configured to:
decipher code output of the LLMs into tangible actions pertaining to a specific language and framework;
generate docker containers for developed applications through a host docker client via a socket service;
select a base image and create configurations of an image by building a docker file by employing the LLMs, the image is a read only template that include instructions for creating a container, and wherein the image is configured for a selected language stack which is deployed by the code deployer persona and a live connection socket is passed to corresponding language kernel.

12. The system as claimed in claim 11, wherein the kernel unit provides for provisions to add plugin executor, wherein the plugin executor provides language specific formatting and instructions to extend capability of the AI personas to setup, code, execute and visualize results of different programming languages.

13. The system as claimed in claim 8, wherein the kernel unit comprises a wrapper that receives instructions to set up a language specific environment such that a code is written in a file structure suggested by the developer AI personas.

14. The system as claimed in claim 13, wherein the developer AI personas are enabled to test each piece of code to ensure functionality and reliability of the code, wherein the generated code is stored as code files in a code repository that is automatically scanned for quality and potential vulnerabilities such that the generated code is functional and secure.

15. The system as claimed in claim 14, wherein the digital PODs comprise a code packaging and maintenance persona that comprises digital AI personas of DevOps engineer and configured to:
receive completed code files and environment details from the code deployer persona;
sync the generated code to specific git repositories and package the code to docker images with configuration enabling syncing of the generated code to specific git repositories; and
package the code to docker images with configuration details, wherein the configurations of the image are converted into absolute image build commands based on rules defined in the generated code, and wherein the packaging and maintenance of code is a result of implementation of the series of steps till the LLMs iteratively determine that the final outcome is comparable to the desired outcome.

16. The system as claimed in claim 15, wherein the digital PODs comprise code deployment and showcase persona that comprises digital AI personas of infrastructure and users for deployment of the application for immediate use by multiple users based on the packaged code based on input provided by code packaging and maintenance person, wherein the deployment of code is a result of implementation of the series of steps till the LLM iteratively determines that the final outcome is comparable to the desired outcome.

17. The system as claimed in claim 15, wherein the code packaging and maintenance persona is configured to structure commands into docker files to build images, wherein structuring involves moving the generated code from a previous development created container to a new container.

18. The system as claimed in claim 1, wherein the digital PODs comprise one or more synthetic data personas for populating synthetic data for demonstrating functional capabilities of developed applications.

19. A method for generating and deploying applications via a cognitive environment implemented via a processor in communication with a memory, the method comprising the steps of:
triggering digital Product Oriented Delivery (PODs) comprising digital Artificial Intelligence (AI) personas in response to a system prompt for:
evaluating a first set of features from an input data using Large Language Model (LLMs) based on a predefined function to generate a first outcome, wherein the first outcome is generated on the basis of external data retrieved from one or more external tools;
comparing the first outcome with the input data and inputting the comparison to the LLMs in the form of a prompt template, wherein the LLMs evaluate whether to proceed with a next step in a series of steps associated with one or more subsequent predefined functions to arrive at a final outcome, wherein the next step involves generating a second outcome by extracting a second set of features from the first outcome and applying a subsequent predefined function over the first outcome; and
implementing the series of steps till the LLMs iteratively determine the final outcome to be comparable to a desired outcome.

20. The method as claimed in claim 19, wherein the method comprises the steps of:
generating code for the application;
interfacing with the LLMs based on micro tasks to generate and deploy code for the application by accessing a kernel unit for writing code;
wherein the generation and deployment of code is a result of implementation of series of steps till the LLMs iteratively determine that the final outcome is comparable to the desired outcome.

21. The method as claimed in claim 20, wherein the method comprises the steps of:
deciphering code output of the LLMs into tangible actions pertaining to a specific language and framework;
generating docker containers for developed applications through a host docker client via a socket service;
selecting a base image and then creating configurations of an image by building a docker file by employing the LLMs, wherein the image is a read only template that include instructions for creating a container, and wherein the image is configured for a selected language stack which is deployed and a live connection socket is passed to corresponding language kernel.

22. The method as claimed in claim 21, wherein the method comprises the steps of:
receiving completed code files and environment details;
syncing the generated code to specific git repositories and package the code to docker images with configuration enabling syncing of the generated code to specific git repositories;
packaging the code to docker images with configuration details, wherein the configurations of the image are converted into absolute image build commands based on rules defined in the generated code, and wherein the packaging and maintenance of code is a result of implementation of the series of steps till the LLMs iteratively determine that the final outcome is comparable to the desired outcome.

23. A computer program product comprising:
a non-transitory computer-readable medium having computer program code stored thereon, the computer-readable program code comprising instructions that, when executed by a processor, causes the processor to:
trigger digital Product Oriented Delivery (PODs) comprising digital Artificial Intelligence (AI) personas in response to a system prompt to:
evaluate a first set of features from an input data using Large Language Model (LLMs) based on a predefined function to generate a first outcome, wherein the first outcome is generated on the basis of external data retrieved from one or more external tools;
compare the first outcome with the input data and input the comparison to the LLMs in the form of a prompt template, wherein the LLMs evaluate whether to proceed with a next step in a series of steps associated with one or more subsequent predefined functions to arrive at a final outcome, wherein the next step involves generating a second outcome by extracting a second set of features from the first outcome and applying a subsequent predefined function over the first outcome; and
implement the series of steps till the LLMs iteratively determine the final outcome to be comparable to a desired outcome.
